(19) United States
(12) Patent Application Publication
(10) Pub. No.: US 2025/0353381 A1
(43) Pub. Date: Nov. 20, 2025

(54) FORCE-BASED DETERMINATION OF A SETPOINT GEAR COMBINATION FOR MULTIPLE DRIVE SYSTEMS

(71) Applicant: MAN Truck & Bus SE, Munich (DE)

(72) Inventor: Felix LAMBRECHT, Munich (DE)

(21) Appl. No.: 19/235,569

(22) Filed: Jun. 12, 2025

Related U.S. Application Data
(63) Continuation of application No. PCT/EP2023/085640, filed on Dec. 13, 2023.

(30) Foreign Application Priority Data
Dec. 13, 2022 (DE) 10 2022 133 140.7

(51) Int. Cl. B60L 15/20; B60L 15/32

(52) U.S. Cl. CPC B60L 15/2054; B60L 15/2045; B60L 15/32; B60L 2240/14; B60L 2240/26; B60L 2240/486

(57) ABSTRACT

The invention relates to a method for determining a target gear combination for a vehicle having at least two drive systems, wherein each drive system drives a vehicle axle and each of the two drive systems has at least one electric motor and at least one transmission with in each case at least two gears; wherein the method comprises the following step: determining the target gear combination on the basis of a comparison of a longitudinal force demand with maximum total driving forces and/or minimum total resistance forces of possible gear combinations of the at least two gears of the at least two transmissions, wherein the maximum total driving forces are the sum of the maximum driving forces of the possible gear combinations and the minimum total resistance forces are the sum of the minimum resistance forces of the possible gear combinations.

### CROSS-REFERENCE TO RELATED APPLICATIONS

This is a bypass continuation of International PCT Application No. PCT/EP2023/085640, filed on Dec. 13, 2023, which claims priority to German Patent Application No. 10 2022 133 140.7, filed on Dec. 13, 2022, which are incorporated by reference herein in their entirety.

### FIELD

The present disclosure relates to a method for determining a target gear combination for a vehicle, in particular a truck and/or a bus, for example a city bus, or a watercraft having at least two drive systems. The vehicle can be driven manually and/or by an automated driving system.

### BACKGROUND

In vehicles which have only one drive system which is driven by an electric motor, the electric motor has to provide a high power in order to be able to sufficiently accelerate the vehicle, in particular a truck. Electric motors operate particularly efficiently from a power utilization of 50 percent and more. Therefore, electric motors which have a very high maximum power operate very inefficiently at low acceleration. Furthermore, it could be the case that only one electric motor, for example at full loading of the truck, cannot provide sufficient power in order to sufficiently accelerate the vehicle. Furthermore, the electric motors can overheat if they are operated with too high a power for too long. Therefore, electric motors can still be used to a limited extent in trucks.

By means of a plurality of drive systems with in each case at least one electric motor which in each case drive a drive axle of the vehicle, by contrast, the drive torques (braking torques) of the drive systems can be added up to form a sufficient total drive torque. For example, the use of a plurality of drive systems, with in each case at least one electric motor, makes it possible to use electric motors with a low power and nevertheless to ensure sufficient acceleration of the vehicle. In order to be able to change the total drive torque of the vehicle, it is advantageous to adapt the power range of an electric motor by means of a transmission. In the case of a plurality of drive systems, a plurality of possible gear combinations of the transmissions of the drive systems result. By means of the different gear combinations of the drive systems, in each case different maximum total drive torques and/or minimum resistance torques (braking torques) can be made available to the vehicle. Therefore, the correct gear combination has to be selected depending on the driving situation.

Furthermore, very different requirements are placed on vehicles, in particular on trucks or watercrafts, that is to say electric motors and/or transmissions with different torque characteristic curves are used in different vehicles in order to be able to adapt the power range and/or the power ranges of the total drive torque optimally to the requirements of the vehicle. Therefore, it is furthermore advantageous to specify a method for calculating a target gear combination which can be adapted automatically or simply to the different requirements of the vehicles.

### SUMMARY

The object of the present invention is to provide a method for calculating the target gear combinations of the transmissions of drivetrains for vehicles having a plurality of drivetrains, which method can provide the drivetrains with a sufficient total driving force and/or total resistance force in situ to the vehicle using a simple calculation method.

Furthermore, it is an object of the present invention to specify a method for calculating the target gear combination which can be transferred to any desired drivetrain concepts having a different number of gears of the transmissions and different torque characteristic curves of the transmissions and/or of the electric motors.

Furthermore, it is an object of the present invention to specify a method for calculating the target gear combination which can be adapted simply to different loadings of the vehicle or to a different vehicle weight.

Furthermore, it is an object of the present invention to specify a vehicle which uses such a method or in which such a method is used.

The invention is based on the concept of using a plurality of motors when driving vehicles in order to increase a driving power of the vehicle. In this case, one or a plurality of electric motors of small or small dimensions can be used, wherein the vehicle can nevertheless apply a high driving power or the required driving power. For this purpose, the aim is to provide a method for selecting and activating a target gear combination for the transmissions which are present between the drive axles and the motors, which method firstly ensures that a sufficient torque can be provided by the drive axles and secondly ensures that the electric motors of the drive systems are utilized sufficiently, with the result that said electric motors are operated in an efficient working range. In order to be able to take into consideration a plurality of drive systems with in each case one electric motor and one transmission when determining the target gear combination, a method is specified which determines the target gear combination in a force-based manner, i.e. on the basis of a comparison of a longitudinal force requirement and a force which can be provided with the individual possible gear combinations of the transmissions of the two drive systems.

These objects are achieved by the features of the independent claims. Refinements are preferably specified in the dependent claims.

According to the invention, a method for determining a target gear combination for a vehicle with at least two drive systems or drivetrains is specified, wherein each drive system drives a vehicle axle and each of the two drive systems has at least one motor and at least one transmission, wherein at least one of the motors is an electric motor and at least one transmission has two gears; wherein the method comprises the following step: determining the target gear combination on the basis of a comparison of a longitudinal force requirement with maximum total driving forces and/or minimum total resistance forces of possible gear combinations of the at least two transmissions, wherein the maximum total driving forces are the sum of the maximum driving forces of the possible gear combinations and the minimum total resistance forces are the sum of the minimum resistance forces of the possible gear combinations.

The target gear combination are the gears which the individual transmissions are intended to have or the gears into which the individual transmissions of the at least two drive systems are intended to be shifted. In this case, a gear is defined by a transmission ratio. For example, the transmissions of the at least two drive systems have two, three or four gears. As a result of the individual gears of the transmissions of the at least two drive systems, the electric motors of the at least two drive systems can apply different torques to the vehicle axles at the same rotational speed of the electric motor.

The driven vehicle axles can be rear axles and/or front axles. The vehicle can also comprise only one rear axle which is driven by a drive system. Furthermore, the vehicle can also comprise two front axles, wherein one or both front axles can be driven. A plurality of front axles and/or a plurality of rear axles can also be driven and/or all vehicle axles can be driven.

The drive system for driving in each case one vehicle axle can comprise an electric motor. However, instead of the electric motor, the drive system can also comprise another and/or further motor, for example an internal combustion engine. Furthermore, the drive systems can be operated freely from one another, that is to say the drive systems are not in direct operative connection with one another. Each of the drive systems comprises one of the at least two transmissions.

The longitudinal force requirement is the force which the vehicle is intended to provide at the present time. The longitudinal force requirement takes into account, for example, how much force is currently being demanded by the vehicle by a driver and/or an automated driving system, and/or a force which will be necessary on account of a current road inclination and/or a road inclination in a route section lying ahead, and/or a force which represents an expected additional force input of the driver and/or of the automated driving system.

The maximum total drive forces are maximum drive forces which the drive systems in a gear combination can provide at the driven axles at maximum in total, or the maximum drive forces with which the drive systems in a gear combination can accelerate the driven axles. The total drive forces are defined in the direction of travel of the vehicle and are therefore positive.

The minimum total resistance forces are minimum resistance forces which all drive systems in a gear combination can provide at the driven axles at minimum in total, that is to say the maximum resistance forces in absolute value with which the drive systems in a gear combination can brake the driven axles. The total resistance forces are defined counter to a direction of travel of the vehicle and are therefore negative. The minimum resistance forces are in absolute value positive and maximum resistance forces of the respective gear of the respective transmission, that is to say the combination of gears of the plurality of transmissions which apply a maximum resistance force.

For example, at the start of the method or during initialization of the algorithm, firstly the at least two transmissions of the at least two drive systems are in neutral.

For example, the method is started or initialized as soon as the longitudinal force requirement is made for the first time after a start of the vehicle and/or after a standstill of the vehicle.

The target gear combination is determined via a comparison of forces which are intended to act on the wheel and can act to the maximum extent and are therefore purely force-based. As a result, the vehicle mass is automatically taken into account in the calculation and the same method can be used for different torque characteristic curves of the transmissions and of the electric motors, for different vehicle types and also for different loading.

Preferably, the determination of the maximum total drive forces and of the minimum total resistance forces takes into account gear combinations as the possible gear combinations in which at least one of the at least two transmissions is in neutral. Preferably, the neutral of one or more transmissions of the drive systems is taken into account as an additional gear in the determination of the gear combinations.

It is also possible, depending on the speed of the vehicle, to omit different gears in the selection or target gear determination, since the activation thereof is improbable or technically impossible. Therefore, the number of practically selectable gears can be restricted and some theoretically possible gear combinations can be disregarded in the practical selection.

As a result, it can be ensured, for example, that the electric motors of the individual drive systems are operated with favorable force utilization. For this purpose, it may be more expedient in terms of energy to deactivate at least one drive system or to operate the transmissions thereof in neutral and, for this purpose, to load the other drive system or the other drive systems to a greater extent and therefore to operate them in a more energy-efficient range. The electric motor can operate in an energy-efficient manner, for example, if the electric motor provides 50 percent or more of its maximum torque. Therefore, for example, the vehicle can be operated in a more energy-efficient manner in situ if a drive system is operated in neutral and, as a result, the electric motor of a further drive system is utilized to a greater extent, that is to say, for example, provides more than 50 percent of its maximum torque.

Preferably, in the method for determining the target gear combination, if the longitudinal force demand is greater than and/or equal to zero, the target gear combination is determined by a comparison of the longitudinal force demand with the maximum total drive forces and is otherwise determined by a comparison with the minimum total resistance forces.

If the longitudinal force demand is positive, it is assumed, for example, that the vehicle is accelerated by the user and/or the automated driving system and/or on account of a positive gradient. Therefore, the target gear combination can be determined which can provide the vehicle with a sufficient or as great as possible total drive torque. If the longitudinal force demand is negative, it can be assumed, for example, that the vehicle is braked by the user and/or the automated driving system, for example on account of a negative gradient. Therefore, the target gear combination can be determined which can provide the vehicle with a sufficient or as great as possible total resistance torque.

Preferably, in the method for determining the target gear combination, if no maximum total drive force is greater than and/or equal to the longitudinal force demand, the gear combination which has the maximum total drive force is selected as the target gear combination. As a result, it can be ensured that the drive systems can be fully utilized.

Preferably, in the method for determining the target gear combination, if no maximum total resistance force is less than and/or equal to the longitudinal force demand, the gear combination which has the minimum total resistance force is selected as the target gear combination. As a result, it can be ensured that the drive systems can be fully utilized.

Preferably, in the method for determining the target gear combination, the target gear combination is determined in such a way that a gear combination is selected in which the gear is changed only in the smallest possible number of the at least two transmissions.

For example, it is first checked whether the actual gear combination is a gear combination with sufficient total drive force or total resistance force. If this is not the case, it can be checked whether a gear combination can be used as the target gear combination, i.e. a gear combination is one of the gear combinations with sufficient total drive force or total resistance force in which a gear has to be changed only in the transmission of one of the drive systems. If this is not the case, it is checked whether a gear combination can be used as the target gear combination in which a gear has to be changed only in two transmissions, etc., in order to ensure that a force or a torque can be transferred at as many drive axles as possible simultaneously, during a shifting operation.

Preferably, if, in a plurality of gear combinations in which in each case the same smallest possible number of gears is changed, that gear combination which has the smallest of the maximum total drive forces and/or the greatest of the minimum total resistance forces is selected. As a result, the drive systems can operate in the gear combination which is most energy-efficient for the vehicle.

Preferably, the longitudinal force demand is determined from a force reserve and a force input.

The force input can be generated or predefined by the driver and/or by the automated driving system. The driver outputs the force input, for example, via a position of an accelerator pedal or via an accelerator pedal position and/or a position of a brake pedal or via a brake pedal position. Subsequently, the accelerator pedal position and/or brake pedal position is converted into a force input. The automated driving system calculates, for example, a target acceleration which is converted into the force input, for example, by multiplication by a vehicle mass. The target acceleration is preferably the acceleration in the longitudinal direction of the vehicle. The force input can also be predefined, for example, in a combined manner by the driver and the automated driving system, for example, in the case of a hill start assistant, the force input of the automated driving system can prevent the vehicle from rolling back on the hill and accelerate the vehicle by the force input of the driver.

Preferably, in the determination of the target gear combination, the force reserve is determined from an acceleration reserve and a vehicle mass.

The force reserve can be equal to the vehicle mass times the vehicle acceleration. The vehicle mass can be a measured value and/or an estimated value. The vehicle mass can either be measured by means of a sensor system or determined, for example, indirectly by means of the acceleration behavior of the vehicle.

The acceleration reserve is a value for the extent to which the total drive force and/or the total resistance force is already utilized, that is to say the acceleration reserve indicates the extent to which the vehicle can still be accelerated and/or decelerated in the current gear combination. Furthermore, the acceleration reserve can determine, as a function of a maximum vehicle acceleration and a maximum vehicle deceleration and a vehicle acceleration or vehicle deceleration, the extent to which the vehicle is intended to be accelerated and/or braked, for example without exceeding system limits of the vehicle and being able to provide the driver with good drivability.

Preferably, the acceleration reserve is determined from a force utilization and an acceleration utilization.

Preferably, the acceleration reserve is determined from a characteristic map which has a value for each force utilization and acceleration utilization, wherein, if the force input is greater than or equal to zero, the value is multiplied by a maximum vehicle acceleration and/or the value is otherwise multiplied by a maximum vehicle deceleration.

The maximum acceleration depends, for example, on the vehicle type and/or a current vehicle speed. Furthermore, the maximum acceleration can be determined in such a way that the energy efficiency during driving is increased. The maximum deceleration depends, for example, on the vehicle type and/or on the vehicle mass. Furthermore, the maximum deceleration can be determined in such a way that the energy efficiency during driving is increased.

Preferably, if the force input is greater than or equal to zero, the force utilization is determined from a ratio of the force input to a maximum total drive force of an actual gear combination of the at least two transmissions and/or the force utilization is otherwise determined from a ratio of the force input to a maximum total resistance force of the actual gear combination of the at least two transmissions.

Preferably, if the force input is greater than and/or equal to zero, the acceleration utilization is determined from a ratio of a vehicle acceleration to the maximum vehicle acceleration and/or the acceleration utilization is otherwise determined from a ratio of a vehicle deceleration to the maximum vehicle deceleration.

The vehicle acceleration corresponds to a positive acceleration or an acceleration equal to zero and the vehicle deceleration corresponds to a negative acceleration. The vehicle acceleration and the vehicle deceleration are preferably specified on the same signal or the vehicle acceleration and the vehicle deceleration are preferably specified on the same value in a specific numerical range.

Preferably, the force input is limited. The force input is preferably limited before the acceleration reserve, the force reserve and the force input are calculated. The force input can also be limited only if the force input is greater than zero. If the force input is less than zero, it may be advantageous not to limit the force input downwards in order to be able to provide the vehicle with a maximum braking torque (maximum recuperation).

Preferably, the limited force input is determined from the minimum of the force input and a sum of a resistance acceleration and the maximum vehicle acceleration times the vehicle mass.

The resistance acceleration depends on a rolling resistance and/or a gradient. The rolling resistance and/or the gradient or road inclination can be determined, for example, by sensors. Furthermore, the rolling resistance and/or the gradient can be read out from the route profile lying ahead and/or individual route sections lying ahead.

The present invention comprises a non-transitory, computer-readable storage medium for physically storing computer program instructions which can be executed by a processor, wherein the computer program instructions define the method for determining the target gear combination.

Furthermore, the present invention comprises a vehicle having at least two drive systems for driving in each case one vehicle axle, wherein each drive system comprises: an electric motor and at least one transmission with in each case at least two gears, wherein the electric motor is in operative connection with the transmission; and a controller which is configured to carry out the method for determining the target gear combination.

### BRIEF DESCRIPTION OF THE DRAWINGS

The invention is described in detail below with reference to the figures:

FIG. 1 shows a vehicle having a controller which is configured to carry out a method for determining a target gear combination.

FIG. 2 shows the vehicle which is illustrated in FIG. 1 from below;

FIG. 3 shows a flow diagram of a method for determining a target gear combination;

FIG. 4 shows a block diagram which is configured to carry out a method for determining the target gear combination;

FIG. 5 shows a block diagram of the module for determining a target gear combination which is illustrated in FIG. 3 and which is configured to determine the target gear combination;

FIG. 6 shows a block diagram of a module which is arranged in the module for determining a target gear combination which is illustrated in FIG. 4 and which is configured to determine the possible gear combinations;

FIG. 7 shows a block diagram of a module which is arranged in the module for determining a target gear combination which is illustrated in FIG. 4 and which is configured to determine the optimum gear combination;

FIG. 8 shows a block diagram of a module for determining a target gear combination which is illustrated in FIG. 3 and which is configured to determine a force reserve;

FIG. 9 shows a block diagram of a module for determining total drive forces which is illustrated in FIG. 3 and which is configured to determine maximum total drive forces of the possible gear combinations and maximum total resistance forces of the possible gear combinations;

FIG. 10 shows a block diagram of the module for determining a limited force input which is illustrated in FIG. 3 and which is configured to limit a force input.

### DETAILED DESCRIPTION

Unless noted otherwise, the same reference signs are used below for identical and identically acting elements.

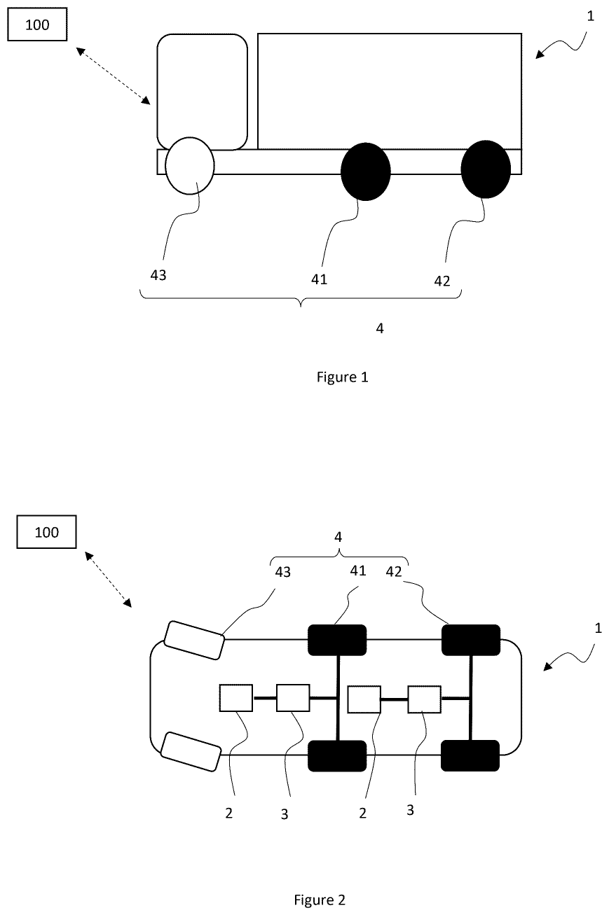

FIG. 1 shows a vehicle 1, in particular a truck, having three vehicle axles 4. The vehicle 1 comprises a front axle 43 and a first rear axle 41 and a second rear axle 42. The first rear axle 41 lies between the front axle 43 and the second rear axle 42. The vehicle 1 furthermore comprises a controller 100 which is configured to carry out a method for determining a target gear combination.

FIG. 2 shows the vehicle 1 according to FIG. 1 from below. The first rear axle 41 and the second rear axle 42 are in each case driven by an electric motor 2. In each case one transmission 3 is arranged between the first rear axle 41 and the second rear axle 42 and the respective electric motor 2.

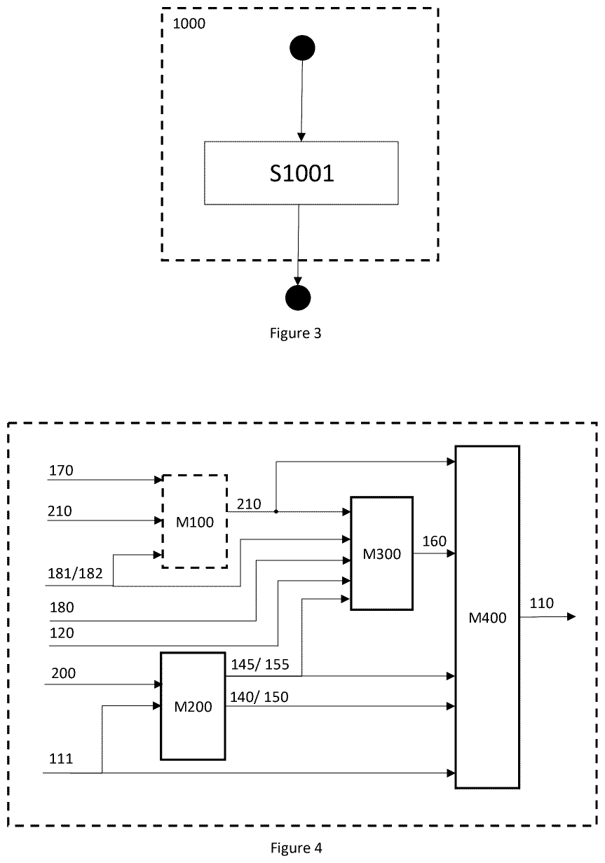

FIG. 3 shows the method for determining the target gear combination 1000 which comprises a step S 1001 for determining the target gear combination on the basis of a comparison of a longitudinal force requirement with maximum total driving forces and/or minimum total resistance forces of possible gear combinations of the at least two gears of the at least two transmissions.

FIG. 4 shows a block diagram for determining the target gear combination 110 which is configured to carry out the method for determining the target gear combination 1000.

The block diagram shows a module for determining a limited force input M 100, a module for determining total driving forces M 200, a module for determining a force reserve M 300 and a module for determining a target gear combination M 400.

The module for determining the target gear combination M 400 can be configured to determine the target gear combination 110. The input variables of the module for determining the target gear combination M 400 can be a force input 210, a force reserve 160, maximum total resistance forces of the possible gear combinations 150, maximum total driving forces of the possible gear combinations 140, a minimum total resistance force of the actual gear combination 155 and a maximum total driving force of the actual gear combination 145. The force reserve 160 indicates how much force, driving force or resistance force is intended to be held in reserve in addition to the force input.

For example, the module for determining the force reserve M 300 is configured to determine the force reserve 160. The input variables of the module for determining the force reserve M 300 are, for example, the force input 210, a maximum vehicle acceleration 181 and a maximum vehicle deceleration 182, a vehicle acceleration or vehicle deceleration 180, a vehicle mass 120, the maximum total driving force of the actual gear combination 145 and the minimum total resistance force of the actual gear combination 155.

The maximum vehicle acceleration 181 and/or the maximum vehicle deceleration 182 depends, for example, on a vehicle speed or the current vehicle speed and/or on a vehicle type. However, the maximum vehicle acceleration 181 and/or the maximum vehicle deceleration 182 can also depend on a route profile lying ahead. The route profile lying ahead can be determined, for example, by a digital map or by a sensor system of the vehicle. The vehicle acceleration or vehicle deceleration 180 is a current acceleration value of the vehicle. The vehicle acceleration or vehicle deceleration 180 can be positive, negative or zero. The maximum total driving force of the actual gear combination 145 is a force which the drive systems of the vehicle can provide at maximum to the vehicle for acceleration in the current gears of the transmissions of the drive systems. The minimum total resistance force of the actual gear combination 155 is a force with which the drive systems of the vehicle can brake the vehicle at maximum in the current gears of the transmissions of the drive systems.

The force input 210 can be limited. For example, the module for determining the limited force input M 100 is configured to determine the limited force input 210 (illustrated by dashed lines). The module for determining the limited force input M 100 is optional. The module for determining the limited force input 210 can have, for example, as input variables the driving input 210 or an as yet unlimited force input 210, a resistance acceleration 170, the maximum vehicle acceleration 181 and/or the maximum vehicle deceleration 182. The resistance acceleration 170 is determined, for example, on the basis of a gradient of the road. The gradient can be the current gradient and/or the gradient in the route profile lying ahead.

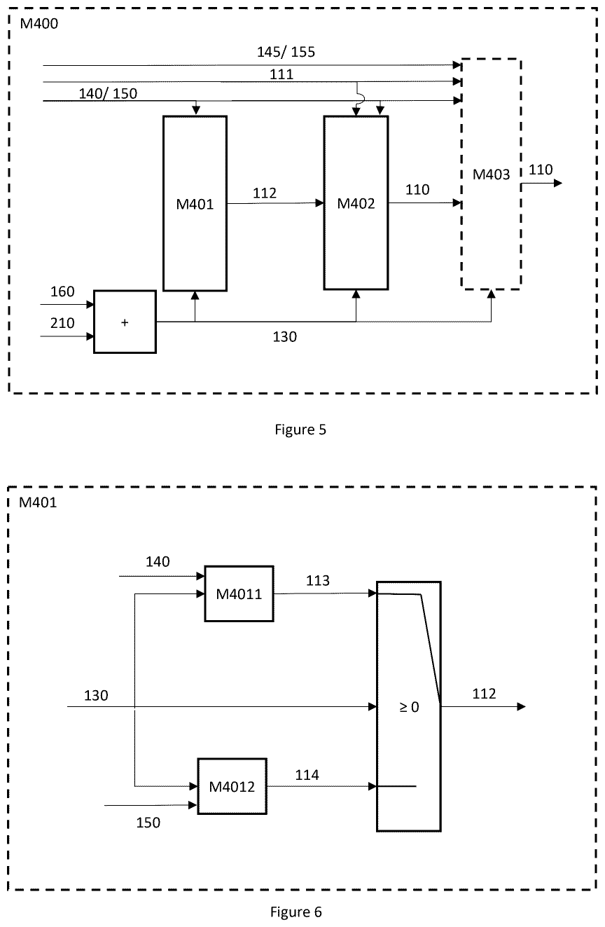

An exemplary embodiment of the module for determining the target gear combination M 400 is illustrated in FIG. 5. The module for determining the target gear combination M 400 comprises, for example, a module for determining possible target gear combination M 401, a module for determining optimum gear combinations M 402 and a module for forming a hysteresis. First, a longitudinal force demand 130 is determined in the module for determining the target gear combination M 400. The longitudinal force demand 130 is calculated, for example, from the sum of the force reserve 160 and the force input 210. The module for determining possible target gear combinations M 401 can be configured to determine the gear combinations with sufficient total drive force or total resistance force 112. Input variables of the module for determining possible target gear combinations M 401 can be the longitudinal force demand 130 and the maximum total driving forces of the possible gear combinations 140 and the maximum total driving forces of the possible gear combinations 150. The module for determining the optimum gear combination M 402 can be configured to determine the target gear combination 110. Input variables of the module for determining the optimum gear combination M 402 can be the gear combinations with sufficient total driving force or total resistance force 112. The module for forming the hysteresis M 403 (illustrated by dashed lines) is optional.

The module for forming the hysteresis M 403 can be configured to prevent the target gear combination from changing too often. Input variables of the module for forming the hysteresis M 403 can be the longitudinal force demand 130, the maximum total driving forces of the possible gear combinations 140, the minimum total resistance forces of the possible gear combinations 150, an actual gear combination 111, a maximum total driving force of the actual gear combination 145 and a minimum total resistance force of the actual gear combination 155. The module for forming the hysteresis M 403 is configured, for example, to change the target gear combination 110 only if the longitudinal force demand 130 can no longer be satisfied by the actual gear combination 155, i.e. if a comparison of the maximum total driving force of the actual gear combination 145 is less than and/or equal to the longitudinal force demand 130 and/or if a comparison of the minimum total resistance force of the actual gear combination 155 is greater than and/or equal to the longitudinal force demand 130. A safety parameter can be taken into account in this comparison. Furthermore, the module for forming the hysteresis M 403 can be configured to wait, after a change of the target gear combination 110, for a time until a renewed change of the target gear combination 110 is possible. Furthermore, the module for forming the hysteresis M 403 can be configured to reduce oscillations of the longitudinal force demand 130, for example by means of a low-pass filter, before the longitudinal force demand 130 is used for determining the target gear combination 110.

The module for determining possible target gear combinations M 401, which is configured to determine gear combinations with sufficient total driving force or total resistance force 112, is illustrated by way of example in FIG. 6. The module for determining possible target gear combinations M 401 can comprise a comparison module M 4011 and a comparison module M 4012. The comparison module 4011 can be configured to determine the gear combinations with sufficient total driving force 113 on the basis of the longitudinal force demand 130 and the maximum total driving forces of the possible gear combinations 140, that is to say gear combinations with sufficient total driving force 113 can be those gear combinations whose maximum total driving forces are greater than and/or equal to the longitudinal force demand 130. The comparison module 4012 can be configured to determine the gear combinations with sufficient total resistance force 114 on the basis of the longitudinal force demand 130 and the maximum total resistance forces of the possible gear combinations 150, that is to say gear combinations with sufficient total driving force 114 can be those gear combinations whose maximum total driving forces are less than and/or equal to the longitudinal force demand 130. By way of example, the module for determining possible target gear combinations M 401 is configured, if the longitudinal force demand 130 is greater than and/or equal to zero, to select the gear combinations with sufficient total driving force 140 as gear combinations with sufficient total driving force or total resistance force 112 and otherwise to select the gear combinations with sufficient total resistance force 150 as gear combinations with sufficient total driving force or total resistance force 112.

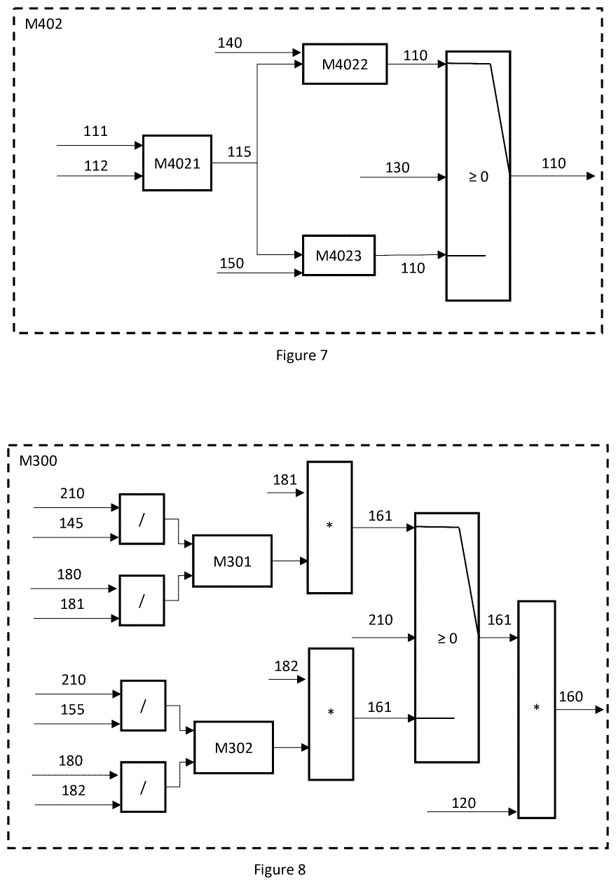

The module for determining the optimum gear combination M 402, which is configured to determine the target gear combination 110, is illustrated by way of example in FIG. 7. The module for determining the optimum gear combination M 402 can comprise a comparison module M 4021, a comparison module M 4022 and a comparison module M 4023.

The comparison module M 4021 can be configured to determine, from an actual gear combination 111 and a gear combination with sufficient total driving force or total resistance force 112, those gear combinations with the smallest possible changes in the gears of the transmissions of the drive systems 115. The comparison module M 4021 is configured, for example, to first check whether the actual gear combination 111 is one of the gear combinations with sufficient total driving force or total resistance force 112. If this is the case, the actual gear combination 111 can be selected as gear combinations with the smallest possible changes in the gears of the transmissions of the drive systems 115. If this is not the case, the comparison module M 4021 can be configured to determine, by a comparison of the actual gear combination 111 with the gear combinations with sufficient total driving force or total resistance force 112, those gear combinations as gear combinations with the smallest possible changes in the gears of the transmissions of the drive systems 115 in which only one gear, subsequently two gears, etc. of the at least two transmissions has or have to be changed.

The comparison module M 4022 can be configured to determine the target gear combination 110 by a comparison of the gear combinations with the smallest possible changes in the gears of the transmissions of the drive systems 115 and the maximum total driving forces of the possible gear combinations 140. That gear combination of the gear combinations with the smallest possible changes in the gears of the transmissions of the drive systems 115 which has the smallest total driving force can be selected as the target gear combination 110. If, for example, there are no gear combinations with sufficient total driving force or total resistance force 112 and therefore also no gear combinations with small changes in the gears of the transmissions of the drive systems 115, the comparison module can furthermore be configured to select that gear combination which has the greatest total driving force as the target gear combination 110.

The comparison module M 4023 can furthermore be configured to determine the target gear combination 110 by a comparison of the gear combinations with the smallest possible changes in the gears of the transmissions of the drive systems 115 and the maximum total resistance forces of the possible gear combinations 150. That gear combination of the gear combinations with the smallest possible changes in the gears of the transmissions of the drive systems 115 which has the greatest total resistance force can be selected as the target gear combination 110. If, for example, there are no gear combinations with sufficient total driving force or total resistance force 112 and therefore also no gear combinations with small changes in the gears of the transmissions of the drive systems 115, the comparison module can furthermore be configured to select that gear combination which has the smallest total resistance force as the target gear combination 110.

The target gear combination 110 can be an output variable of the comparison module M 4022 and an output variable of the comparison module M 4023. Therefore, the module for determining the optimum gear combination 110 can furthermore be configured to select the output variable of the comparison module M 4022 or the output variable of the comparison module M 4023 as the target gear combination 110 depending on the longitudinal force demand 130. For example, the module for determining the optimum gear combination is configured to select the output variable of the comparison module M 4022 as the target gear combination 110 if the longitudinal force demand 130 is greater than and/or equal to zero. Furthermore, the module for determining the optimum gear combination can be configured, if the longitudinal force demand 130 is less than and/or equal to zero, to select the output variable of the comparison module M 4023 as the target gear combination 110.

The module for determining the force reserve M 300, which is configured to calculate the force reserve 160, is illustrated by way of example in FIG. 8. The module for determining the force reserve M 300 comprises the characteristic map M 301 and the characteristic map M 302. The module for determining the force reserve M 300 can be configured to determine the force reserve from an acceleration reserve 161 and a vehicle mass 120. For this purpose, for example, the acceleration reserve 161 can be multiplied by the vehicle mass 120. The module for determining the force reserve M 300 can be configured to determine the acceleration reserve 161 for a braking case and a drive case. The module for determining the force reserve M 300 can be configured to determine the acceleration reserve 161 for the drive case if the force input is greater than and/or equal to zero and otherwise to determine the acceleration reserve 161 for the braking case. The module for determining the force reserve M 300 can be configured to first determine a force utilization and an acceleration utilization. The force utilization in the drive case can be a ratio of the force input 210 to the maximum total driving force of the actual gear combination 145. The acceleration utilization in the drive case can be a ratio of the vehicle acceleration or vehicle deceleration 180 to the maximum vehicle acceleration 181. The force utilization in the braking case can be a ratio of the force input 210 to the minimum total resistance force of the actual gear combination 155. The acceleration utilization in the braking case can be a ratio of the vehicle acceleration or vehicle deceleration 180 to the maximum vehicle acceleration 181. Furthermore, the module for determining the force reserve M 300 can be configured to read out a value in the drive case from a characteristic map M 301 and/or in the braking case from a characteristic map M 302 depending on the force utilization and the acceleration utilization. Subsequently, the module for determining the force reserve M 300 can be configured to determine the acceleration reserve 161 by multiplication of the value in the drive case by a maximum vehicle acceleration 181 and in the braking case by the maximum vehicle deceleration 182.

By means of the characteristic map M 301 and/or the characteristic map M 302, the acceleration reserve 161 can be adapted adaptively to the driving situation, for example independently of the current speed. This leads, with a low configuration outlay, to a state of the drive system or drive train which is appropriate to the driving situation. The configuration outlay is low because it combines the driving situation, which depends, for example, on the driving resistance, utilization of the current driving force, current acceleration and maximum acceleration, into relative variables and can therefore be used simply for each driving situation. Preferably, an appropriate, but not excessively large, acceleration reserve 161 is determined, which leads to the electric motors of the drive systems being operated in an efficient operating range, for example with a torque of between 60 percent and 90 percent, and only if necessary in a higher range of the torque. Furthermore, changes in the drive system or in the drive train, for example power reduction on account of high temperature of the electric motors of the drive systems, are automatically taken into account.

For example, the characteristic map M 301 and/or the characteristic map M 302 can have the following characteristic properties:
If the acceleration utilization is high and the force utilization is low, the acceleration reserve 161 can be small and/or equal to zero. This can lead to a target gear combination with a smaller maximum total driving force than the maximum total driving force of the actual gear combination.
If the acceleration utilization is low to negative and the force utilization is high, the acceleration reserve 161 can be high. This can lead to a target gear combination with a greater maximum total driving force than the maximum total driving force of the actual gear combination.
If the acceleration utilization is high and the force utilization is high, the acceleration reserve 161 can be small and/or equal to zero. This can lead to a target gear combination which continues to have a sufficient maximum total driving force.
If the force utilization is low to zero, the acceleration reserve 161 can be small and/or equal to zero. This can lead to a target gear combination with a smaller maximum total driving force than the maximum total driving force of the actual gear combination. This leads to the force utilization increasing again.

For example, the characteristic map M 301 and/or the characteristic map M 302 are/is designed such that smooth transitions of the acceleration reserve are achieved in the event of a change in the force input. Furthermore, the characteristic map M 301 and/or the characteristic map M 302 can be designed such that, in combination with an axle load-dependent distribution of the longitudinal force demand to the at least two drive systems, a moderate utilization of the adhesion value of the at least two drive systems results, wherein a further drive system of the at least two drive systems is preferably connected only if the utilization of the adhesion value of the at least two drive systems is high. The adhesion value means an adhesion of the wheels of the vehicle axles of the drive systems on the ground or the road. Furthermore, the method for determining a target gear combination can be transferred to any desired types and combinations of drive systems by the simple application of the characteristic map M 301 and/or the characteristic map M 302. Furthermore, the characteristic map M 301 and/or the characteristic map M 302 can have the same values or the same value depending on the force utilization and the acceleration utilization, i.e. the same characteristic map can be used for the drive case and the braking case.

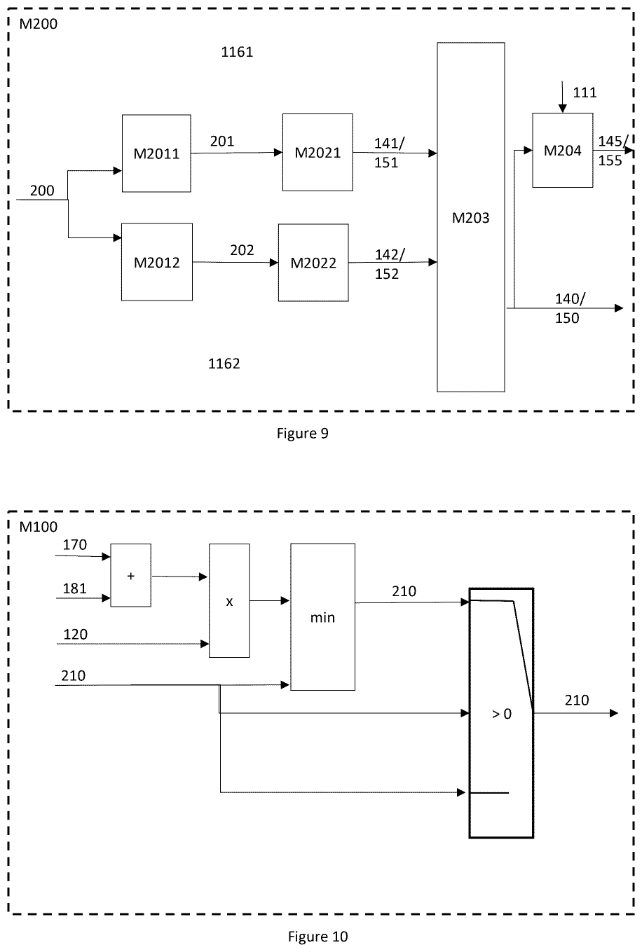

The module for determining the total driving forces M 200, which is configured to determine the maximum total driving forces of the possible gear combinations 140, the minimum total resistance forces of the possible gear combinations 150, the maximum total driving force of the actual gear combination 145 and the minimum total resistance force of the actual gear combination 155 as a function of the vehicle speed 200, is shown by way of example in FIG. 9. The module for determining the total driving forces M 200 can be configured to first determine maximum driving forces and resistance forces for each of the at least two drive systems. By way of example, FIG. 9 shows a determination of maximum driving forces of a first drive system 141, a determination of minimum resistance forces of a first drive system 151, a determination of maximum driving forces of a second drive system 142 and a determination of minimum resistance forces of a second drive system 152 of the at least two drive systems.

In order to determine the maximum driving forces of the first drive system 141 and the determination of the minimum resistance forces of the first drive system 151 in the individual gears of the transmission of the first drive system, the module for determining the total driving forces M 200 can comprise a module M 2011 and a module M 2021. Firstly, the module for determining the total driving forces M 200 can be configured to read out rotational speeds of the motor 201 of the first drive system for each gear depending on the vehicle speed 200 from the module M 2011. Subsequently, the module M 2021 can be configured to determine the maximum driving forces of the first drive system 141 and the minimum resistance forces of the first drive system 151 depending on the rotational speeds of the motor 201 of the first drive system for each gear. Firstly, for this purpose, the module M 2021 can be configured to determine maximum driving torques and resistance torques for each gear of the first drive system depending on the rotational speeds of the motor 201 and subsequently to determine the maximum driving forces of the first drive system 141 and the minimum resistance forces of the first drive system 151 depending on the maximum driving torques and resistance torques and transmission ratios for each gear of the first drive system.

In order to determine the maximum driving forces of the second drive system 142 and the determination of the minimum resistance forces of the second drive system 152 in the individual gears of the transmission of the first drive system, the module for determining the total driving forces M 200 can comprise a module M 2012 and a module M 2022. Firstly, the module for determining the total driving forces M 200 can be configured to read out rotational speeds of the motor 202 of the second drive system for each gear depending on the vehicle speed 200 from the module M 2012. Subsequently, the module M 2022 can be configured to determine the maximum driving forces of the second drive system 142 and the minimum resistance forces of the second drive system 152 depending on the rotational speeds of the motor 202 of the second drive system for each gear. Firstly, the module M 2022 can be configured to determine maximum driving torques and resistance torques for each gear of the second drive system depending on the rotational speeds of the motor 202 of the second drive system and subsequently to determine the maximum driving forces of the second drive system 142 and the minimum resistance forces of the second drive system 152 depending on the maximum driving torques and resistance torques and transmission ratios for each gear of the second drive system.

Subsequently, the module for determining the total driving forces M 200 can be configured to determine the maximum total driving forces of the possible gear combinations 140 and the minimum total resistance forces of the possible gear combinations 150 by means of a module M 203. For this purpose, the module M 203 can be configured to firstly determine the possible gear combinations. In the determination of the possible gear combination, the individual transmissions of the drive systems in neutral can also be taken into account. Furthermore, the module 203 can be configured to add the maximum driving forces of the at least two drive systems, for example the maximum driving force of the first drive system 141 and the maximum driving force of the second drive system 142, for the possible gear combination in order to determine the maximum total driving forces of the possible gear combinations 140. Furthermore, the module 203 can be configured to add the minimum resistance forces of the at least two drive systems, for example the minimum resistance force of the first drive system 151 and the minimum resistance forces of the second drive system 152, for the possible gear combination in order to determine the minimum total resistance forces of the possible gear combinations 150. If the neutral of the transmissions of the at least two drive systems is taken into account for the possible gear combinations, a driving force and/or a resistance force of zero, for example, is assumed for the drive system whose transmission is in neutral.

Subsequently, the module for determining the total driving forces M 200 can be configured to determine the maximum total driving force of the actual gear combination 145 and the minimum total resistance force of the actual gear combination 155 from the maximum total driving forces of the possible gear combinations 140, the minimum total resistance forces of the possible gear combinations 150 and the actual gear combination 111 by means of a module M 204.

The module for determining a limited force input M 100, which is configured to limit the force input 130, is illustrated by way of example in FIG. 10. The module for determining the limited driving input M 100 can be configured not to limit the force input 210 if the force input 210 is less than or equal to zero. Furthermore, the module for determining the limited force input M 100 can be configured to limit the force input 210 if the force input 210 is greater than zero. The limited force input 210 can be, for example, the minimum of the force input 210 which is predefined, for example, by the driver and/or the automated driving system, and a value which is formed from the multiplication of a sum of the resistance acceleration 170 and the maximum vehicle acceleration 181 by the vehicle mass 12.

### List of Reference Numerals

1 Vehicle
2 Electric motor
3 Transmission
4 Vehicle axles
41 First rear axle
42 Second rear axle
43 Front axle
100 Controller
110 Target gear combination
111 Actual gear combination
112 Gear combinations with sufficient total driving force or total resistance force
113 Gear combinations with sufficient total driving force
114 Gear combinations with sufficient total resistance force
115 Gear combinations with small changes in the gears of the transmissions of the drive systems
120 Vehicle mass
130 Longitudinal force demand
140 Maximum total driving forces of the possible gear combinations
141 Maximum driving forces of the first drive system (for each gear)
142 Maximum driving forces of the second drive system (for each gear)
145 Maximum total driving force of the actual gear combination
150 Minimum total resistance forces of the possible gear combinations
151 Minimum resistance forces of the first drive system (for each gear)
152 Minimum resistance forces of the second drive system (for each gear)
155 Minimum total resistance force of the actual gear combination
160 Force reserve
161 Acceleration reserve
170 Resistance acceleration
180 Vehicle acceleration or vehicle deceleration
181 Maximum vehicle acceleration
182 Maximum vehicle deceleration
200 Vehicle speed
201 Rotational speeds of the first electric motor (for each gear)
202 Rotational speeds of the second electric motor (for each gear)
210 force input
1000 Method for determining a target gear combination
M100 Module for determining a limited force input
M200 Module for determining total driving forces
M300 Module for determining a force reserve
M400 Module for determining a target gear combination
M401 Module for determining possible gear combinations
M402 Module for determining an optimum gear combination
M403 Module for forming a hysteresis

1. A method for determining a target gear combination for a vehicle having at least two drive systems, wherein each drive system drives a vehicle axle and each of the two drive systems has at least one motor and at least one transmission, wherein at least one of the transmissions has at least two gears;
wherein the method comprises the following step:
determining the target gear combination on the basis of a comparison of a longitudinal force demand with maximum total driving forces and minimum total resistance forces of possible gear combinations of the at least two transmissions,
wherein the maximum total driving forces are a sum of the maximum driving forces of the possible gear combinations, and the minimum total resistance forces are a sum of the minimum resistance forces of the possible gear combinations.

2. The method according to claim 1, wherein:
if the longitudinal force demand is greater than or equal to zero, the target gear combination is determined by a comparison of the longitudinal force demand with the maximum total driving forces, and
if the longitudinal force demand is not greater than or equal to zero, the target gear combination is determined by a comparison with the minimum total resistance forces.

3. The method according to claim 1,
wherein if no maximum total driving force of the maximum total driving forces is greater than or equal to the longitudinal force demand, the gear combination which has the maximum total driving force is selected as the target gear combination; and
wherein if no maximum total resistance force of the minimum total resistance forces is less than or equal to the longitudinal force demand, the gear combination which has the minimum total resistance force is selected as the target gear combination.

4. The method according to claim 1, wherein the target gear combination is determined in such a way that a gear combination is selected in which the gear is changed in a smallest possible number of the at least two transmissions, and
wherein the target gear combination is determined in such a way that a gear is changed in at least one transmission of the at least two transmissions.

5. The method according to claim 4, wherein, if, in a plurality of gear combinations in which in each case the same smallest possible number of gears is changed, a gear combination which has the smallest maximum total driving force of the maximum total driving forces and the greatest minimum total resistance force of the minimum total resistance forces is selected.

6. The method according to claim 1, wherein the longitudinal force demand is determined from a force reserve and a force input.

7. The method according to claim 6, wherein the force reserve is determined from an acceleration reserve and a vehicle mass.

8. The method according to claim 7, wherein the acceleration reserve is determined from a force utilization and an acceleration utilization.

9. The method according to claim 8, wherein the acceleration reserve is determined from a characteristic map which has a value for each force utilization and acceleration utilization,
wherein, if the force input is greater than or equal to zero, the value is multiplied by a maximum vehicle acceleration, and
if the force input is not greater than or equal to zero, the value is multiplied by a maximum vehicle deceleration.

10. The method according to claim 9, wherein:
if the force input is greater than or equal to zero, the force utilization is determined from a ratio of the force input to a maximum total driving force of an actual gear combination of the at least two transmissions, and
if the force input is not greater than or equal to zero, the force utilization is otherwise determined from a ratio of the force input to a maximum total resistance force of the actual gear combination of the at least two transmissions; and
wherein, if the force input is greater than or equal to zero, the acceleration utilization is determined from a ratio of a vehicle acceleration to the maximum vehicle acceleration, and
if the force input is not greater than or equal to zero, the acceleration utilization is determined from a ratio of a vehicle deceleration to the maximum vehicle deceleration.

11. The method according to claim 7, wherein the force input is limited.

12. The method according to claim 11, wherein the limited force input is determined from the minimum of the force input and a sum of a resistance acceleration and the maximum vehicle acceleration times the vehicle mass.

13. A non-transitory computer-readable storage medium for instructions thereon, the instructions when executed by one or more processors cause the one or more processors to perform the method according to claim 1.

14. A vehicle having at least two drive systems, wherein each drive system is provided for driving in each case one vehicle axle and each drive system comprises:
an electric motor and at least one transmission with in each case at least two gears, wherein the electric motor is in operative connection with the transmission; and
a controller which is configured to carry out the method according to claim 1.
